(19) United States
(12) Patent Application Publication
(10) Pub. No.: US 2014/0004324 A1
(43) Pub. Date: Jan. 2, 2014

(54) LOW DIELECTRIC RESIN COMPOSITION, APPLICABLE COPPER-CLAD LAMINATE AND PRINTED CIRCUIT BOARD

(71) Applicant: ELITE ELECTRONIC MATERIAL (ZHONGSHAN), ZhongShan City (CN)

(72) Inventors: CHEN-YU HSIEH, Taoyuan County (TW); CHANG-YUAN LI, ZhongShan City (CN)

(73) Assignee: ELITE ELECTRONIC MATERIAL (ZHONGSHAN) CO.,LTD., ZhongShan City (CN)

(21) Appl. No.: 13/679,777

(22) Filed: Nov. 16, 2012

(30) Foreign Application Priority Data
Jun. 28, 2012 (CN) 201210217552.9

(51) Int. Cl. C08L 71/12; B32B 3/10; C08L 79/00; B32B 15/08; C08L 25/08; C08L 57/00

(52) U.S. Cl. CPC C08L 71/123; C08L 25/08; C08L 57/00; C08L 79/00; B32B 15/08; B32B 3/10; B82Y 30/00
USPC 428/209; 525/132; 524/508; 524/430; 524/437; 524/433; 524/436; 524/427; 524/428; 524/404; 524/444; 524/443; 524/424; 524/432; 524/413; 524/449; 524/406; 524/405; 524/417; 524/451; 524/445; 524/423; 428/461; 977/742

(57) ABSTRACT

A resin composition includes (A) 100 parts by weight of poly(phenylene oxide) resin with styrene end group; (B) 5 to 75 parts by weight of olefin copolymer; and (C) 1 to 150 parts by weight of cyanate resin with poly(phenylene oxide) functional group. The resin composition is characterized by specific composition and proportion conducive to achieving a low dielectric constant, a low dielectric loss, and a high thermal tolerance and preparing a prepreg or a resin film, thereby being applicable to copper-clad laminates and printed circuit boards.

### CROSS-REFERENCE TO RELATED APPLICATION

This non-provisional application claims priority under 35 U.S.C. §119(a) on Patent Application No(s). 201210217552.9 filed in China on Jun. 28, 2012, the entire contents of which are hereby incorporated by reference.

### FIELD OF THE INVENTION

The present invention relates to resin compositions, and more particularly, to a low dielectric resin composition applicable to copper-clad laminates (CCL) and printed circuit boards.

### BACKGROUND OF THE INVENTION

To get in line with the global trend of environmental protection and eco-friendly regulations, electronic product manufacturers nowadays are developing and manufacturing halogen-free electronic products. Advanced countries and electronic manufacturing giants set forth schedules of launching mass production of halogen-free electronic products. As a result of the promulgation of the Restriction of Hazardous Substances (RoHS) by the European Union, hazardous substances, such as lead, cadmium, mercury, hexavalent chromium, poly-brominated biphenyl (PBB), and poly-brominated diphenyl ether (PBDE), are strictly prohibited from being used in manufacturing electronic products or their parts and components. A printed circuit board (PCB) is an indispensable and fundamental basis of the semiconductor industry and electronic industry; hence, printed circuit boards bore the brunt of international halogen-free regulations when international organizations set forth strict requirements of the halogen content of printed circuit boards. For example, the International Electrotechnical Commission (IEC) 61249-2-21 requires that bromide content and chloride content shall be less than 900 ppm and the total halogen content shall be less than 1500 ppm. The Japan Electronics Packaging and Circuits Association (JPCA) requires that both bromide content and chloride content shall be less than 900 ppm. To enforce its green policies, Greenpeace calls on manufacturers worldwide to get rid of polyvinyl chloride (PVC) and brominated flame retardants (BFRs) from their electronic products in order to conform with the lead-free and halogen-free requirements of green electronics. Hence, the industrial sector nowadays is interested in rendering related materials halogen-free and sees this technique as one of its key research topics.

Electronic products nowadays have the trend toward compactness and high-frequency transmission; hence, circuit boards nowadays typically feature a high-density layout and increasingly strict material requirements. To mount high-frequency electronic components on a circuit board, it is necessary that the substrate of the circuit board is made of a material of a low dielectric constant (Dk) and dielectric dissipation factor (Df) in order to maintain the transmission speed and the integrity of a signal transmitted. To allow the electronic components to function well at a high temperature and a high-humidity environment, it is necessary for the circuit board to be heat resistant, fire resistant, and of low hygroscopicity. Epoxy resin is adhesive, heat resistant, and malleable and thus is widely applicable to encapsulants and copper clad laminates (CCL) of electronic components and machinery. From the perspective of fire prevention, epoxy resin is incapable of flame retardation, and thus epoxy resin has to acquire flame retardation capability by including a flame retardant therein. For example, a halogen, such as bromine, is included in epoxy resin to bring about flame retardation capability thereof.

Recent years see electronic products becoming lighter and smaller and circuits becoming finer, thereby disadvantaging heavy halogen compounds. When exposed to a high temperature for a long period of time, a halogen compound is likely to decompose and thereby erode a fine circuit. Furthermore, combustion of discarded used electronic parts and components produces hazardous compounds, such as halogen compounds, which are environmentally unfriendly. To find an alternative to the aforesaid halogen compound-based flame retardant, researchers attempt to use a phosphorous compound as a flame retardant, for example, adding phosphate ester (U.S. Pat. No. 6,440,567) or red phosphorus (EP patent No. 0763566) to an epoxy resin composition. However, phosphate ester undergoes hydrolysis readily to produce an acid, thereby compromising its tolerance to migration. Although red phosphorus is good at flame retardation, it falls into the category of hazardous compounds under the firefighting law, because it produces a trace of a flammable, toxic gas known as phosphine in a warm humid environment.

A conventional circuit board manufacturing method, such as a conventional method of manufacturing a copper-clad substrate (also known as copper clad laminate, CCL), involves heating and combining a reinforcement material (such as a glass fabric) and a thermosetting resin composition made of an epoxy resin and a curing agent to form a prepreg, and then laminating the prepreg and the upper and lower copper foils together at a high temperature and a high pressure. The prior art usually teaches using a thermosetting resin composed of an epoxy resin and a hydroxyl-containing phenol novolac resin curing agent. Due to the combination of the phenol novolac resin and the epoxy resin, epoxide ring-opening reactions end up with another hydroxyl which not only increases the dielectric constant (Dk) and the dielectric dissipation factor inherently, but also reacts with water readily and thereby renders the thermosetting resin more hygroscopic.

U.S. Pat. No. 7,255,925 discloses a thermosetting resin composition composed of cyanate ester resin, dicyclopentadiene (DCPD) epoxy resin, silica, and a thermoplastic resin. The thermosetting resin composition is characterized by a low dielectric constant (Dk) and a low dielectric dissipation factor. However, a method for manufacturing the thermosetting resin composition of U.S. Pat. No. 7,255,925 requires the use of a halogen-containing (such as bromine-containing) flame retardant, such as tetrabromocyclohexane, hexabromocyclodecane, or 2,4,6-tris(tribromophenoxy)-1,3,5-triazine. However, the bromine-containing flame retardant causes environmental pollution readily during the thermosetting resin composition manufacturing process, the using processing of thermosetting resin composition, and even after the thermosetting resin composition has been discarded or recycled. To ensure a low dielectric dissipation factor, a low hygroscopicity, a high cross-linking density, a high glass transition temperature, a high connectivity, appropriate thermal expansion, heat resistance, and fire resistance of copper clad laminates, it is necessary to select an epoxy resin, a curing agent, and a reinforcement material carefully.

The major considerations given to electrical properties include the dielectric constant (Dk) and the dielectric dissipation factor. In general, the signal transmission speed of a substrate is inversely proportional to the square root of the dielectric constant (Dk) of the material from which the substrate is made, and thus the minimization of the dielectric constant (Dk) of the substrate material is usually advantageously important. The lower the dielectric dissipation factor is, the lesser the signal transmission attenuation is; hence, a material of a low dielectric dissipation factor provides satisfactory transmission quality.

Accordingly, it is important for printed circuit board material suppliers to develop materials of a low dielectric constant (Dk) and a low dielectric dissipation factor, and apply the materials to high-frequency printed circuit board manufacturing.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a resin composition with a view to attaining a low dielectric constant, a low dielectric loss, and a high thermal tolerance.

It is an objective of the present invention to provide a resin composition characterized by specific composition and proportion conducive to attaining a low dielectric constant, a low dielectric loss, and a high thermal tolerance and preparing a prepreg or a resin film, thereby being applicable to copper-clad laminates (CCL) and printed circuit boards.

In order to achieve the above and other objectives, the present invention provides a resin composition, comprising (A) 100 parts by weight of poly(phenylene oxide) resin with styrene end group; (B) 5 to 75 parts by weight of olefin copolymer; and (C) 1 to 150 parts by weight of cyanate resin with poly(phenylene oxide) functional group.

The resin composition of the present invention is for use in manufacturing a prepreg, a resin film, a copper-clad laminate (CCL), and a printed circuit board. The resin composition of the present invention is characterized by specific composition and proportion conducive to achieving a low dielectric constant, a low dielectric loss, and a high thermal tolerance and preparing a prepreg or a resin film, thereby being applicable to copper-clad laminates and printed circuit boards.

According to the present invention, the molecular structure of the poly(phenylene oxide) resin with styrene end group is expressed by formula (1) below.

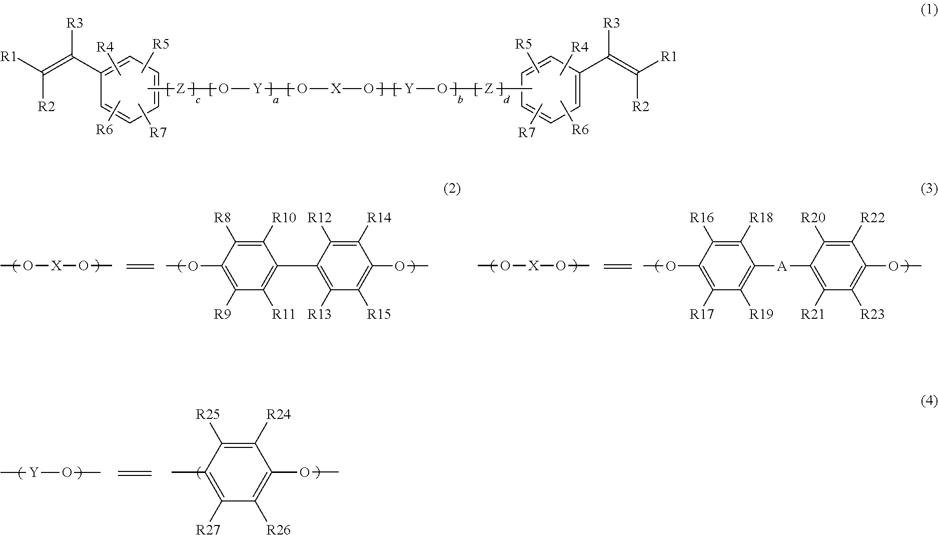

wherein R1, R2, R3, R4, R5, R6, and R7 are independent of each other and represent a hydrogen atom, fluorine atom, alkyl group, halogenated alkyl group or phenyl group. Furthermore, —(O—X—O)— is expressed by formula (2) or formula (3), wherein R8, R9, R10, R14, R15, R16, R17, R22, and R23 are independent of each other and represent halogen atoms, alkyl group having 1-6 carbon atoms, or phenyl group. R11, R12, R13, R18, R19, R20, and R21 are independent of each other and represent hydrogen atoms, halogen atoms, alkyl group having 1-6 carbon atoms, or phenyl group. The letter A denotes aliphatic or cyclic hydrocarbons having 1-20 carbon atoms and a substitutable group. Furthermore, —(Y—O)— denotes an arrangement of a molecular structure defined by formula (4) or an irregular arrangement of at least two molecular structures defined by formula (4), wherein R24 and R25 are independent of each other and represent halogen atoms, alkyl group having 1-6 carbon atoms, or phenyl group, whereas R26 and R27 are independent of each other and represent hydrogen atoms, halogen atoms, alkyl group having 1-6 carbon atoms, or phenyl group. The letter Z denotes an organic group that contains at least one carbon atom and contains oxygen atoms, nitrogen atoms, sulfur atoms, or halogen atoms. Letter a and letter b each denote an integer that ranges between 0 and 300 on condition that the situation where both a and b equal zero never occurs. Letter c and letter d are each the integer 0 or 1.

The poly(phenylene oxide) resin with styrene end group of the present invention has lower dielectric properties, namely a lower dielectric constant and a lower dielectric loss, than conventional poly(phenylene oxide) resin with two hydroxyl end groups does.

The olefin copolymer of the present invention is methyl styrene copolymer or cyclic olefin copolymer, wherein the molecular structure of cyclic olefin copolymer is expressed by formula (5) below.

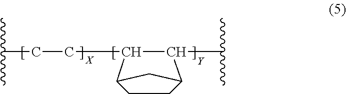

The olefin copolymer of the present invention lacks a hydroxyl group (—OH functional group) and thus manifests low dielectric properties.

The resin composition of the present invention comprises 100 parts by weight of poly(phenylene oxide) resin with styrene end group and 5 to 75 parts by weight of olefin copolymer and thus manifests a relatively low dielectric constant and dielectric loss. In case the olefin copolymer included in the resin composition is less than 5 parts by weight, the expected electrical properties of the resultant resin composition cannot be achieved. In case the olefin copolymer included in the resin composition is more than 75 parts by weight, the thermal tolerance of the resultant resin composition will deteriorate. The prior art discloses poly(phenylene oxide) resin with two hydroxyl end groups which can be cross-linked to epoxy resin efficiently. By contrast, it is difficult for the poly(phenylene oxide) resin with styrene end group of the present invention to be cross-linked to epoxy resin, and, as a result, the poly(phenylene oxide) resin with styrene end group of the present invention manifests unsatisfactory crosslinking properties and unsatisfactory substrate performance. Hence, the present invention involves employing olefin copolymer to cross-link with poly(phenylene oxide) resin with styrene end group with a view to enhancing the crosslinking properties of the resin composition of the present invention and improving the substrate performance thereof.

Among resins, poly(phenylene oxide) resin usually has relatively low dielectric properties. Furthermore, poly(phenylene oxide) resin with styrene end group has a much lower dielectric constant and a much lower dielectric loss than poly(phenylene oxide) resin in general and thus enables the resin composition of the present invention to manifest very low dielectric properties and thereby meet the requirement for low dielectric properties of a resin layer of a substrate. According to the present invention, the 5 to 75 parts by weight of olefin copolymer further reduces the dielectric constant and the dielectric loss and enables it to be better cross-linked to poly(phenylene oxide) resin with styrene end group.

The molecular structure of cyanate resin with poly(phenylene oxide) functional group of the present invention is expressed by formula (6) below.

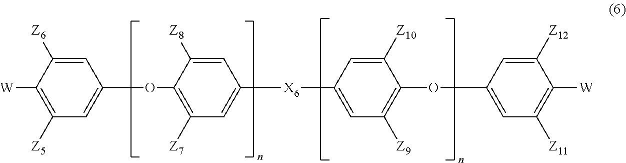

X₆ denotes a covalent bond, —SO₂—, —C(CH₃)₂—, —CH(CH₃)—, or —CH₂—. Z₅ through Z₁₂ are independent of each other and represent hydrogen or methyl. The letter W denotes —O—C≡N. The letter n denotes an integer equal to or greater than 1.

Specifically speaking, the molecular structure of the cyanate resin with poly(phenylene oxide) functional group is preferably expressed by at least one of formula (7) through formula (10) as follows:

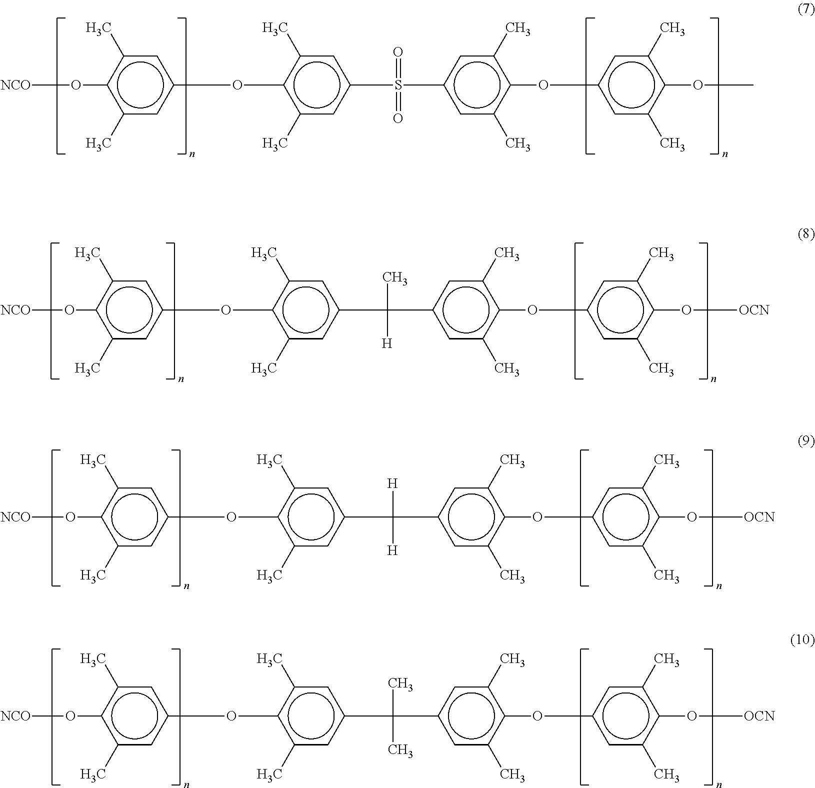

wherein n denotes an integer equal to or greater than 1.

The cyanate resin with poly(phenylene oxide) functional group of the present invention has a lower dielectric constant and a lower dielectric loss than bisphenol A cyanate resin of the prior art does.

The resin composition of the present invention comprises 100 parts by weight of poly(phenylene oxide) resin with styrene end group and 1 to 150 parts by weight of cyanate resin with poly(phenylene oxide) functional group and thereby not only increases the crosslinking between poly(phenylene oxide) resin with styrene end group and olefin copolymer but also enhances the bonding between the three resins. Cyanate resin with poly(phenylene oxide) functional group not only manifests enhanced crosslinking properties but also increases its glass transition temperature and its bonding with a piece of copper foil. Accordingly, advantageously low dielectric properties of cyanate resin with poly(phenylene oxide) functional group, olefin copolymer, and poly(phenylene oxide) resin with styrene end group are attained.

The resin composition of the present invention preferably further comprises benzoxazine resin. The benzoxazine resin comprises bisphenol A benzoxazine resin, bisphenol F benzoxazine resin, benzoxazine resin with dicyclopentadiene (DCPD), and phenolphthalein benzoxazine resin. To be specific, preferably, the formula of the molecular structure of the benzoxazine resin comprises at least one of formulae (11) through (13) below.

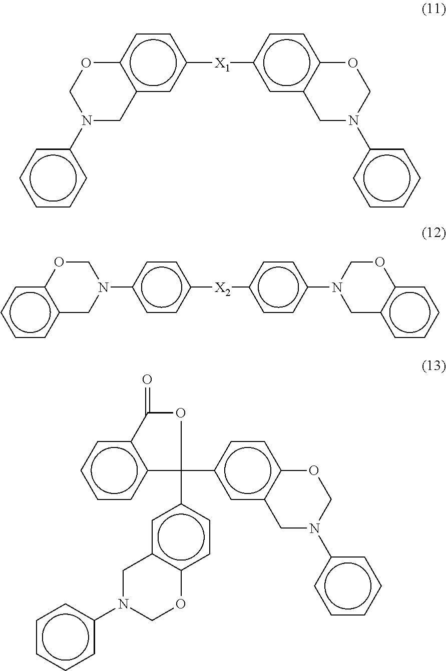

X₁ and X₂ denote R, Ar, or —SO₂—. R denotes —C(CH₃)₂—, —CH(CH₃)—, —CH₂—, and substituted or unsubstituted dicyclopentadiene (DCPD). Ar denotes substituted or unsubstituted benzene, biphenyl, naphthalene, novolac, bisphenol A, bisphenol A novolac, bisphenol F, and bisphenol F novolac functional group. Brand names of the benzoxazine resin marketed by Huntsman include LZ-8280, and LZ-8290.

The resin composition of the present invention comprises 100 parts by weight of poly(phenylene oxide) resin with styrene end group and 5 to 50 parts by weight of benzoxazine resin to thereby reduce the overall hygroscopicity of the resin composition and enhance the rigidity thereof. In case of less than 5 parts by weight of benzoxazine resin, it will be impossible to meet the requirement for reduction of hygroscopicity and enhancement of rigidity. In case of more than 50 parts by weight of benzoxazine resin, it will result in deterioration of copper-clad laminate thermal tolerance.

To render the resin composition of the present invention less flammable, it is necessary to employ flame retardant compounds, including phosphate compounds or nitrogen-containing phosphate compounds which are, however, not restrictive of the present invention. To be specific, flame retardant compounds preferably comprise at least one of the following compounds: bisphenol diphenyl phosphate, ammonium polyphosphate, hydroquinone bis-(diphenyl phosphate), bisphenol A bis-(diphenylphosphate), tri(2-carboxyethyl)phosphine (TCEP), tris(chloroisopropyl)phosphate (TCPP), trimethyl phosphate (TMP), dimethyl methyl phosphonate (DMMP), resorcinol dixylenylphosphate (RDXP, such as PX-200), melamine polyphosphate, phosphazo compounds, phosphazene compounds, 9,10-dihydro-9-oxa-10-phosphaphenanthrene-10-oxide (DOPO) and its derivatives or resins, melamine cyanurate, and tri-hydroxy ethyl isocyanurate, which are not restrictive of the present invention. Good examples of the flame retardant compounds include DOPO compounds, DOPO resin (such as DOPO-HQ, DOPO-PN, DOPO-BPN), DOPO-containing epoxy resin. Good examples of DOPO-BPN include bisphenol novolac compounds, such as DOPO-BPAN, DOPO-BPFN, and DOPO-BPSN.

The resin composition of the present invention further comprises an inorganic filler. The purpose of the inorganic filler is to not only enable the resin composition to manifest enhanced thermal conductivity, enhanced thermal expansion properties, and enhanced mechanical strength, but also enable the inorganic filler to be uniformly distributed in the halogen-free resin composition.

The inorganic filler comprises silicon dioxide (molten, non-molten, porous, or hollow), aluminum oxide, aluminum hydroxide, magnesium oxide, magnesium hydroxide, calcium carbonate, aluminum nitride, boron nitride, aluminum silicon carbide, silicon carbide, sodium carbonate, titanium dioxide, zinc oxide, zirconium oxide, quartz, diamond powder, quasi diamond powder, graphite, magnesium carbonate, potassium titanate, ceramic fiber, mica, boehmite (AlOOH), zinc molybdate, ammonium molybdate, zinc borate, calcium phosphate, calcinated talc, talc, silicon nitride, mullite, calcinated kaolinite, clay, alkaline magnesium sulfate whisker, mullite whisker, barium sulfate, magnesium hydroxide whisker, magnesium oxide whisker, calcium oxide whisker, carbon nanotube, nanoscale silicon dioxide, related inorganic powder, or powder particles having an organic nucleus coating and intended to decorate an insulator. The inorganic filler is spherical, fiber-like, plate-like, particle-like, sheet-like, or needle-shaped, and is selectively pretreated with a silane coupling agent.

The inorganic filler comprises particulate powder with a particle diameter of less than 100 μm, preferably particulate powder with a particle diameter of 1 μm to 20 μm, and most preferably nanoscale particulate powder with a particle diameter of less than 1 μm. The needle-shaped inorganic filler comprises powder with a diameter of less than 50 μm and a length of 1 to 200 μm.

The inorganic filler of the present invention is provided in the proportion of 100 parts by weight of poly(phenylene oxide) resin with styrene end group to 10-1000 parts by weight of the inorganic filler. In case of less than 10 parts by weight of the inorganic filler, the resultant resin composition will lack significant thermal conductivity, enhanced thermal expansion, and enhanced mechanical strength. In case of more than 1000 parts by weight of the inorganic filler, the resultant resin composition manifests deteriorated porosity flow and deteriorated copper foil attachment.

As regards electrical properties, the resin composition of the present invention comprises preferably molten silicon dioxide, porous silicon dioxide, hollow silicon dioxide, spherical silicon dioxide, or a combination thereof.

The resin composition of the present invention further comprises at least one selected from the group consisting of epoxy resin, cyanate resin, styrene maleic anhydride, phenol resin, novolac resin, amine cross-linking agent, phenoxy resin, styrene resin, polybutadiene resin, polyamide resin, polyimide resin, polyester resin, and a modified derivative thereof.

The resin composition of the present invention further comprises epoxy resin selected from the group consisting of bisphenol A epoxy resin, bisphenol F epoxy resin, bisphenol S epoxy resin, bisphenol AD epoxy resin, phenol novolac epoxy resin, bisphenol A novolac epoxy resin, o-cresol novolac epoxy resin, trifunctional epoxy resin, tetrafunctional epoxy resin, multifunctional epoxy resin, dicyclopentadiene (DCPD) epoxy resin, phosphorus-containing epoxy resin, DOPO-containing epoxy resin, DOPO-HQ-containing epoxy resin, p-xylene epoxy resin, naphthalene epoxy resin, benzopyran epoxy resin, biphenyl novolac epoxy resin, phenol aralkyl novolac epoxy resin, and a combination thereof.

The resin composition of the present invention preferably comprises dicyclopentadiene (DCPD) epoxy resin or naphthalene epoxy resin. The purpose of dicyclopentadiene (DCPD) epoxy resin is to reduce the hygroscopicity of the resin composition. The purpose of naphthalene epoxy resin is to enhance the rigidity of the resin composition and enhance the thermal tolerance of the resin composition.

The resin composition of the present invention further selectively comprises a surfactant, a silane coupling agent, a curing accelerator, a toughening agent, or a solvent. The purpose of the surfactant is to ensure the uniform distribution of the inorganic filler in the resin composition to thereby prevent agglomeration of the inorganic filler. The purpose of the toughening agent is to improve the roughness of the resin composition. The purpose of the curing accelerator is to increase the reaction rate of the resin composition. The purpose of the solvent is to alter the solid contents of the resin composition and modify the viscosity of the resin composition.

The silane coupling agent comprises silanes and siloxanes which are of the following types, namely amino silane, amino siloxane, epoxy silane, and epoxy siloxanes, according to functional group.

The curing accelerator comprises a catalyst, such as a lewis base or a lewis acid. The lewis base includes imidazole, boron trifluoride-amine, ethyltriphenyl phosphonium chloride, 2-methylimidazole (2MI), 2-phenyl-1H-imidazole (2PZ), 2-ethyl-4-methylimidazole (2E4MZ), triphenylphosphine (TPP), and/or 4-dimethylaminopyridine (DMAP). The lewis acid comprises metallic salt compounds, such as the metallic salts of manganese, iron, cobalt, nickel, copper, and zinc, namely metallic catalysts, such as zinc caprylate, and cobalt caprylate. Furthermore, the curing accelerator of the present invention comprises peroxide, cationic polymerization initiator, tetraphenylphosphonium tetraphenylborate (TPPK), or a combination thereof.

The toughening agent of the present invention comprises rubber resin, carboxyl-terminated butadiene acrylonitrile (CTBN) rubber, and/or core-shell rubber.

The solvent of the present invention comprises methanol, ethanol, ethylene glycol monomethyl ether, acetone, butone (methyl ethyl ketone), methyl isobutyl ketone, cyclohexanone, toluene, xylene, methoxyethyl acetate, ethoxyethyl acetate, propoxyethyl acetate, ethyl acetate, dimethyl formamide, propylene glycol methyl ether, or a mixture thereof.

To achieve a low dielectric constant and a low dielectric loss, the resin composition of the present invention has to have as small a number of residual hydroxyl groups as possible. That is to say, it is necessary for the present invention to increase the crosslinking density of the resins. Hence, given the disclosed proportions of constituents of the resin composition of the present invention, not only is the crosslinking of the constituents of the resin composition of the present invention optimized, but the amount of residual resin carrying any intact functional group is minimized

Another objective of the present invention is to provide a resin film characterized by low dielectric properties, thermal tolerance, and low hygroscopicity, and is halogen-free so as to be applicable to an insulating material for use with laminates and circuit boards.

The resin film of the present invention is characterized by the resin composition whereby the resin film undergoes a heating process so as to be semi-cured. For instance, the halogen-free resin composition is positioned on a polyethylene terephthalate (PET) film and heated up to form a resin film.

Yet another objective of the present invention is to provide a resin coated copper (RCC) foil which comprises at least one piece of copper foil and at least one insulating layer. The copper foil further comprises an alloy that contains copper, aluminum, nickel, platinum, silver, and gold. The resin film of the present invention is attached to at least one piece of copper foil. Then, the PET film is removed. Finally, the resin film and the copper foil are heated and cured at high temperature and high pressure, so as to form an insulating layer coupled tightly to the copper foil.

A further objective of the present invention is to provide a prepreg of high mechanical strength, low dielectric properties, thermal tolerance, and low hygroscopicity, and being halogen-free. Hence, the prepreg of the present invention comprises a reinforcing material and the resin composition, wherein the resin composition is attached to the reinforcing material and heated up at a high temperature to become semi-cured. The reinforcing material is a fibrous material, a woven fabric, or a non-woven fabric, such as a glass fabric, and is intended to increase the mechanical strength of the prepreg. Also, the reinforcing material can be selectively pretreated with a silane coupling agent or a siloxane coupling agent. For example, the glass fabric is pretreated with the silane coupling agent.

When heated up at a high temperature or heated up at a high temperature and a high pressure, the prepreg can be cured to form a cured prepreg or a solid-state insulating layer, wherein, if the resin composition contains a solvent, the solvent will evaporate and escape during a high-temperature heating process.

A further objective of the present invention is to provide a copper-clad laminate of high mechanical strength, low dielectric properties, thermal tolerance, and low hygroscopicity, and being halogen-free, and is particularly applicable to a circuit board for use in high-speed high-frequency signal transmission. Hence, the present invention provides a copper-clad laminate (CCL) comprises two or more pieces of copper foil and at least one insulating layer. The copper foil further comprises an alloy of copper, aluminum, nickel, platinum, silver, and/or gold. The insulating layer is formed by curing the prepreg at a high temperature and a high pressure, for example, by compressing the prepreg sandwiched between two pieces of copper foil at a high temperature and a high pressure.

The copper-clad laminate of the present invention has at least one of the following advantages: a low dielectric constant, and a low dielectric loss. The copper-clad laminate can be further processed by a circuit making process to thereby form a circuit board. The circuit board is able to operate at a strict environment, for example at a high temperature and a high pressure, without deteriorating in terms of performance, even after an electronic component has been mounted on the circuit board.

A further objective of the present invention is to provide a printed circuit board of high mechanical strength, low dielectric properties, thermal tolerance, and low hygroscopicity, and being halogen-free, and is suitable for use in high-speed high-frequency signal transmission. The circuit board comprises at least one copper-clad laminate. The circuit board is manufactured by a conventional process.

To further disclose the present invention and enable persons skilled in the art to implement the present invention, the present invention is hereunder illustrated with several embodiments. The following embodiments are illustrative rather than restrictive of the scope of the present invention. Any modification and change made by persons skilled in the art to the following embodiments of the present invention without departing from the spirit thereof shall fall within the scope of the present invention.

### DETAILED DESCRIPTION OF THE PREFERRED EMBODIMENTS

To allow persons skilled in the art to gain insight into the objectives, features, and benefits of the present invention, the present invention is hereunder illustrated with specific embodiments.

Constituents of a resin composition in embodiments 1 through 5 (E1˜E5) and comparisons 1 through 2 (C1˜C2) are enumerated in Table 1. The constituents of the resin compositions in the embodiments 1 through 5 and comparisons 1 through 2 are evenly mixed in a blender batch by batch before being put into an impregnation tank. Then, a glass fabric is passed through the impregnation tank to allow the resin composition to adhere to the glass fabric before undergoing a heating and baking process to become semi-cured, thereby forming a prepreg.

A piece of 18-μm copper foil, four pieces of the prepreg prepared by the same batch, and another piece of 18-μm copper foil are stacked in sequence before being laminated against each other in vacuum at 220° C. for two hours to form a copper-clad laminate (CCL). The four pieces of prepreg are cured to form an insulating layer between the two copper foils.

A physical properties measurement process is performed on the non-copper-containing substrate of the etched aforesaid copper clad laminates and copper foils. The physical properties measurement process measures the glass transition temperature Tg, copper-containing substrate heat resistance (T288), copper-containing substrate immersion tin test (solder dip 288° C., 10 seconds, testing heat resistance, S/D), immersion tin test (pressure cooking at 121° C. for one hour, testing solder dip at 288° C. for 20 seconds, then inspecting for board rupture, PCT) after non-copper-containing substrate PCT absorbing moisture, the tension between the copper foil and the substrate (peeling strength, half ounce copper foil, P/S), dielectric constant (Dk) (wherein Dk is the lower the better), dielectric dissipation factor (wherein Df is the lower the better). The results of measurement of the resin compositions of embodiments 1 through 5 and comparisons 1 through 2 are shown in Table 2.

TABLE 1

| ingredients | | E1 | E2 | E3 | E4 | E5 | C1 | C2 |
|---|---|---|---|---|---|---|---|---|
| poly(phenylene oxide) | OPE-2st (2200) | 100 | 100 | 100 | 100 | 100 | 0 | 100 |
| resin with styrene end | | | | | | | | |
| group | | | | | | | | |
| cyclic olefin copolymer | Topas 5013 | 4.42 | 0 | 0 | 2.21 | 10 | 0 | 10 |
| methyl styrene copolymer | Piccolastic A75 | 0 | 4.42 | 4.42 | 2.21 | 0 | 0 | 10 |
| cyanate resin with | BTP-6020S | 50 | 65 | 35 | 75 | 25 | 100 | 0 |
| poly(phenylene oxide) | | | | | | | | |
| functional group | | | | | | | | |
| epoxy resin | HP-7200 | 0 | 4.42 | 4.42 | 0 | 0 | 50 | 0 |
| | HP-5000 | 4.42 | 0 | 0 | 20.42 | 17.56 | 0 | 4.24 |
| flame retardant | SPB-100 | 42 | 42 | 42 | 42 | 42 | 42 | 36 |
| (phoshazenes) | | | | | | | | |
| cross-linking agent | TAIC | 2 | 4 | 6 | 10 | 15 | 0 | 20 |
| inorganic filler | SQ-2500 | 80 | 80 | 80 | 80 | 80 | 80 | 30 |
| curing accelerator | TPPK | 0.25 | 0.25 | 0.25 | 0.25 | 0.25 | 0.25 | 0.25 |
| catalyst | Zn²⁺ | 0.04 | 0.04 | 0.04 | 0.04 | 0.04 | 0.04 | 0.04 |
| antioxidant | TPB | 0.62 | 0.62 | 0.62 | 0.8 | 0.62 | 0.62 | 0.62 |
| peroxide | DCP | 0.2 | 0.2 | 0.2 | 0.2 | 0.2 | 0.2 | 0.2 |

TABLE 2

| property test | test parameter | E1 | E2 | E3 | E4 | E5 | C1 | C2 |
|---|---|---|---|---|---|---|---|---|
| Tg | DMA | 205.94 | 208.09 | 211.34 | 215.43 | 218.05 | 228.98 | 180.65 |
| S/D | dip cycles | >20 | >20 | >20 | >20 | >20 | >15 | 10 |
| Solder dip | 288° C. (s) | >300 | >300 | >300 | >300 | >300 | >120 | 120 |
| PCT (3 hr) | dip 288° C., 20 s | Pass | Pass | Pass | Pass | Pass | Fail | Fail |
| P/S | ½ oz Cu foil | 6.21 | 6.31 | 6.04 | 6.34 | 6.12 | 6.1 | 5.92 |
| Dk | 1 M/1 G (2G) | 3.54/3.56 | 3.45/3.47 | 3.48/3.51 | 3.58/3.56 | 3.45/3.48 | 3.5/3.4 | 3.92/3.9 |
| | | (3.52) | (3.35) | (3.32) | (3.52) | (3.25) | (3.68) | (3.12) |
| Df | 1 M/1 G (2G) | 0.0025/ | 0.0034/ | 0.0045/ | 0.0045/ | 0.0021/ | 0.0066/ | 0.0012/ |
| | | 0.0035 | 0.0036 | 0.0058 | 0.0058 | 0.0026 | 0.0064 | 0.0022 |
| | | (0.0052) | (0.0058) | (0.0056) | (0.0056) | (0.0051) | (0.0092) | (0.0068) |
| built-up thin | | 2116 * 4 | 2116 * 4 | 2116 * 4 | 2116 * 4 | 2116 * 4 | 2116 * 2 | 2116 * 4 |
| core (T/C) | | | | | | | | |
| construction | | | | | | | | |

A comparison of embodiments 1 through 5 and comparison 1 reveals that comparison 1 does not contain poly(phenylene oxide) resin with styrene end group and thus features an overly high dielectric loss and an unsatisfactory thermal tolerance.

A comparison of embodiments 1 through 5 and comparison 2 reveals that comparison 2 does not contain cyanate resin with poly(phenylene oxide) functional group and thus features an overly high dielectric constant and an unsatisfactory thermal tolerance.

Embodiments 1 through 5 indicate that the resin composition of the present invention comprises poly(phenylene oxide) resin with styrene end group, olefin copolymerolefin copolymer, and cyanate resin with poly(phenylene oxide) functional group and thus is advantageously characterized by a low dielectric constant, a low dielectric loss, and a high thermal tolerance.

Hence, the present invention meets the three requirements of patentability, namely novelty, non-obviousness, and industrial applicability. Regarding novelty and non-obviousness, the present invention discloses a resin composition characterized by specific composition and proportion conducive to achieving a low dielectric constant, a low dielectric loss, and a high thermal tolerance and preparing a prepreg or a resin film, thereby being applicable to copper-clad laminates and printed circuit boards. Regarding industrial applicability, products derived from the present invention meet market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A resin composition for copper clad laminate, comprising:
(A) 100 parts by weight of poly (phenylene oxide) resin with styrene end group;
(B) 5 to 75 parts by weight of olefin copolymer; and
(C) 1 to 150 parts by weight of cyanate resin with poly (phenylene oxide) functional group.

2. The resin composition of claim 1, wherein the olefin copolymer is methyl styrene copolymer or cyclic olefin copolymer.

3. The resin composition of claim 1, further comprising benzoxazine resin.

4. The resin composition of claim 3, further comprising 5 to 50 parts by weight of benzoxazine resin.

5. The resin composition of claim 1, further comprising at least one selected from the group consisting of epoxy resin, cyanate resin, phenol resin, novolac resin, amine cross-linking agent, phenoxy resin, benzoxazine resin, styrene resin, polybutadiene resin, polyamide resin, polyimide resin, and polyester resin.

6. The resin composition of claim 1, further comprising an inorganic filler, the inorganic filler being at least one selected from the group consisting of silicon dioxide, aluminum oxide, aluminum hydroxide, magnesium oxide, magnesium hydroxide, calcium carbonate, aluminum nitride, boron nitride, aluminum silicon carbide, silicon carbide, sodium carbonate, titanium dioxide, zinc oxide, zirconium oxide, quartz, diamond powder, quasi diamond powder, graphite, magnesium carbonate, potassium titanate, ceramic fiber, mica, boehmite (AlOOH), zinc molybdate, ammonium molybdate, zinc borate, calcium phosphate, calcinated talc, talc, silicon nitride, mullite, calcinated kaolinite, clay, alkaline magnesium sulfate whisker, mullite whisker, barium sulfate, magnesium hydroxide whisker, magnesium oxide whisker, calcium oxide whisker, carbon nanotube, nanoscale silicon dioxide, related inorganic powder, or powder particles having an organic nucleus coating and intended to decorate an insulator.

7. The resin composition of claim 1, further comprising at least one selected from the group consisting of bisphenol diphenyl phosphate, ammonium polyphosphate, hydroquinone bis-(diphenyl phosphate), bisphenol A bis-(diphenylphosphate), tri(2-carboxyethyl)phosphine (TCEP), tris(chloroisopropyl)phosphate (TCPP), trimethyl phosphate (TMP), dimethyl methyl phosphonate (DMMP), resorcinol dixylenylphosphate (RDXP, such as PX-200), melamine polyphosphate, phosphazene compounds, 9,10-dihydro-9-oxa-10-phosphaphenanthrene-10-oxide (DOPO) and its derivatives or resins, melamine cyanurate, and tri-hydroxy ethyl isocyanurate.

8. The resin composition of claim 1, further comprising at least one selected from the group consisting of a curing accelerator, a toughening agent, a flame retardant, a surfactant, a silane coupling agent, and a solvent.

9. A prepreg comprising the resin composition of claim 1.

10. A resin film comprising the resin composition of claim 1.

11. A copper-clad laminate comprising the prepreg of claim 9 or the resin film of claim 9.

12. A printed circuit board comprising the copper-clad laminate of claim 11.
